(19) United States
(12) Patent Application Publication
(10) Pub. No.: US 2016/0139081 A2
(43) Pub. Date: May 19, 2016

(54) SYSTEM AND METHOD FOR A NONDESTRUCTIVE TESTING OF METAL FUSION WELDS AT THIN-WALLED PIPES

(71) Applicants: Fraunhofer-Gesellschaft zur Foerderung der angewandten Forschung e.V., Muenchen (DE); Ing.-Buero Pruefdienst Uhlemann, Peitz (DE)

(72) Inventors: Frank UHLEMANN, Cottbus (DE); Susanne HILLMANN, Langebrueck (DE); David M. SCHILLER-BECHERT, Dresden (DE); Zsolt BOR, Dresden (DE)

(21) Appl. No.: 14/633,618

(22) Filed: Feb. 27, 2015

(51) Int. Cl. G01N 29/04

(52) U.S. Cl. CPC G01N 29/043; G01N 2291/0234; G01N 2291/044; G01N 2291/267

(57) ABSTRACT

The invention relates to a system for the nondestructive testing of metal fusion welds at thin-walled pipes having a maximum wall thickness of 6 mm. It is formed with at least one test probe for the emission and detection of soundwaves as well as with at least one adjustment body which is composed of a material which is the same or a material having at least approximately the same acoustic properties as the respective pipe to be tested. The outline dimensions and the diameters/thicknesses of the adjustment body are at least approximately the same as those of the respective pipe to be tested. A plurality of blind bores each having different lengths/depths starting from their openings to their bases are formed in the adjustment body.

The invention relates to a system and to a method for a non-destructive testing of metal fusion welds at thin-walled pipes. In this respect, a use is provided in the testing of pipes having nominal wall thicknesses of up to a maximum of 10 mm or preferably up to a maximum of 6 mm.

Performing and analyzing the tests of circumferential pipe fusion welds at pipes having a nominal wall thickness of less than 6 mm using semi-automated phased array technology using soundwaves is very problematic and is therefore also not covered by the standard “DIN EN ISO 13588, Non-destructive testing of welds—Ultrasonic testing—Use of automated phased array technology”.

The difficulties in the testing in this respect also arise due to a substantial defocusing of the sound beam used by the curved pipe walls. A reliable defect localization and assessment of welds at such pipes using ultrasound technology was therefore previously not possible.

A testing of such circumferential pipe fusion welds was previously carried out exclusively by means of radiography testing. In this respect, a substantial effort is required and in particular a use was in particular not possible, or was only possible with difficulty, with very limited spatial circumstances.

It is therefore the object of the invention to provide possibilities for a nondestructive testing at thin-walled pipes having a wall thickness of less than 6 mm using ultrasound technology which also achieve an adequate testing accuracy with these small nominal wall thicknesses.

An important advantage of ultrasound testing is that the truly critical defects can be more frequently be found in the welds with it. Weld seam defects having a notch effect such as cracks, fusion defects and lack of penetration can only be detected with limitations in radiography testing.

In accordance with the invention, this object is achieved by a system having the features of claim 1. A method for carrying out a test can take place in accordance with claim 9.

In the system in accordance with the invention, at least one test probe is present for the emission and detection of soundwaves as well as at least one adjustment body which is composed of a material which is the same or a material having at least approximately the same acoustic properties as the respective thin-walled pipe to be tested. The outline dimensions and the diameters of the adjustment body are the same as those of the respective pipe to be tested. In addition, a plurality of blind bores each having different lengths/depths starting from their openings to their bases are formed in the adjustment body.

Respective corresponding adjustment bodies are accordingly required for different pipe geometries and in part also pipe materials.

The blind bores in the adjustment body should in this respect be aligned such that the central longitudinal axis of the blind bores is aligned at the same angle as the areas of the pipes which have been welded to one another.

Welds are typically formed as V weld seams at thin-walled pipes. The end faces to be welded to one another of the two pipes to be welded to one another are accordingly chamfered at an angle prior to the welding. In these cases, the central longitudinal axis of the blind bores are aligned at an angle which is the complementary angle to 90° in which the end faces of the pipe ends to be welded are aligned. The central longitudinal axis of the blind bores can therefore be aligned at an angle α with respect to the surface of the adjustment body from which soundwaves are coupled into the adjustment body and soundwaves are then coupled into the adjustment body at the same angle α.

Different ultrasound test probes can be used as the test probe. In the simplest case, this can be a test probe as a single ultrasound transceiver with which soundwaves can be emitted and detected. At any rate, it should be designed for a transit time detection of the soundwaves as is customary in the test probes which can be used in the invention.

It is, however, favorable with such a simple test probe, to be able to vary the angle of incidence of emitted soundwaves onto a weld seam and onto the base of blind holes on an adjustment.

Phased array sensors known per se can advantageously be used for carrying out the test which simplify the test and which can considerably cut the time required therefor. Phased array sensors have a plurality of elements with which soundwaves can be emitted and detected. These elements are frequently present in a row arrangement and/or column arrangement at such a sensor. Soundwaves can be emitted by a corresponding control of the elements which have different angles which may also still vary in this respect and can optionally also be emitted at different times.

There is particularly advantageously the possibility of being able to operate elements of a phased array sensor which emit and detect soundwaves in a plurality of groups and in this respect to operate the individual groups respectively individually independently of one another. Soundwaves can thus also be coupled into the material of a pipe to be tested or of an adjustment body at different positions and in this respect the angle of incidence of the soundwaves can also be varied, which comes at least very close to a pivot movement. The soundwaves reflected back are accordingly also incident on elements of the phased array sensor from varying directions at corresponding angles for their detection.

In this respect a fault/defect can be recognized and displayed as an exceeding or falling below of a predefinable threshold value. In this respect, the individual measured signals are corrected using apertures, thresholds, comparison lines, depth compensation curves or similar tools, which will have to be looked at again in the following.

In the method in accordance with the invention, a test of a pipe and an adjustment using at least one test probe are carried out. Soundwaves are coupled in using the test probe at a plurality of positions and at different angles from the surface of the respective pipe to be tested and from the surface of the adjustment body. In this respect, the soundwaves are directed to the weld seam of the pipe and, in the adjustment, onto bases of blind bores. The sound waves reflected back are detected by the test probe and a comparison is carried out using the detected measured signal amplitude(s) for an exceeding or falling below of a predefinable threshold value for recognizing a fault/defect.

It is advantageous to determine depth compensation curves by means of the known configuration and position of the bases of the blind bores, with which depth compensation curves a compensation of the damping takes place with differently long paths which soundwaves cover in the material of the pipe by a corresponding amplification dependent on the sound path of measured signals which were detected with soundwaves.

Elements of a phased array sensor emitting and detecting soundwaves should be combined into at least two groups and the groups should be able to be operated independently of one another in time. In this respect, soundwaves can be emitted by one group and can then be detected in the material of a pipe or of an adjustment body, while one or more other groups are inactive.

A substantial component of the system is at least one adjustment body which has to be produced individually for the respective test work. It serves the sensitivity adjustment of the test system.

An adjustment body is formed from a material which is composed of the same material or a material having at least approximately the same acoustic properties as the respective pipe to be tested and is manufactured with at least very largely the same outline dimensions such as the outer diameter and the nominal wall thickness. A plurality of blind bores are formed in the material of the adjustment body, each having different lengths and depths starting from the opening of the blind bores to their bases. Flat-base bores are particularly preferred in which the base surface is aligned perpendicular to the inner walls of the blind bore and is formed as a planar surface.

The adjustment body should be at least so long that the flat-base bores can be introduced with sufficient spacing from the base or from the wall of the body forming the adjustment body or of the pipe end and the test probe emitting and detecting soundwaves can be displaced in parallel with the central longitudinal axis of the adjustment body such that all blind bores have sound directed at them at least also after 3 deflections/reflections at a wall of the adjustment body.

The blind bores should be introduced from a side at an angle which is adapted to the seam preparation. The central longitudinal axis of the blind bores should therefore be aligned at an angle which corresponds to the complementary angle at 90° of the angle at which the surfaces/edges to be welded together of the pipe ends welded to a pipe.

The center of the bore base should be arranged at different depths of the pipe to be tested on the use of three blind bores in an adjustment body. Depths of ¼, ½ and ¾ of the nominal wall thickness of the respective pipe to be tested are favorable here. The depth, diameter and angle of inclination of the blind bores should be kept in tight, fixed tolerances of desired values.

Alternatively to the flat-base bores, blind bores having semispherical bases can also be formed in an adjustment body. They have to be substantially larger in diameter than flat-base bores with the same measurement sensitivity. They can therefore only be used with large wall thicknesses and have to be separately validated due to their different sensitivity with respect to flat-base bores.

With blind bores having semispherical bases, it is not the center of the hemisphere which should be arranged in a corresponding depth in the material of the adjustment body, but rather the deepest point. On a use of, for example, three such blind bores, the deepest point should then be arranged at ¼, ½ and ¾ of the nominal wall thickness of the respective pipe to be tested. It should additionally be ensured that the hemispheres are fully formed and have a sufficiently large spacing from the outer wall of the adjustment body.

An adjustment body has to be especially manufactured for the respective application and serves the checking of functionality of the total system and the adjustment of the sensitivity at regular intervals.

Adjustment bodies should be manufactured from a thin-walled pipe having the same material or a material having comparable acoustic properties and the same outline dimensions with the outer diameter and wall thickness as the respective pipe to be tested.

The length of the pipe which forms the adjustment body should be at least so large that the complete test probe holder, and optionally its guide, can be attached thereto.

At least one bore extending perpendicular through a pipe wall and having a fixed diameter can be introduced as an additional control reflector and a control body can thus be provided for the system in accordance with the invention. These bores should be arranged as centrally as possible at the pipe forming the control body and the peripheral position should be marked for positioning the test probe holder.

A maximum sound field coverage, redundant where possible, of the total weld seam should be observed for the test. When a phased array sensor is used as a test probe, a single sector sweep is usually not sufficient for a maximum defect localization. Phased array sensors make it possible to carry out sector scans which are spatially offset and independent of one another at varying angles of the emitted soundwaves using a test probe. The individual elements of a phased array sensor emitting and detecting ultrasound waves can be divided into at least two groups, which are spatially separate from one another and which are operated separately from one another for the testing of a weld seam. With a phased array sensor having 32 elements, these elements can thus be divided into two groups, with the first group comprising the elements 1-16 and the second group comprising the elements 17-32.

These groups can be operated in the test at a thin-walled pipe or at an adjustment body such that they execute a sector sweep which at least covers the angular range from 90° less the angle of the inclination of the respective surface(s) of the weld preparation for the weld seam connection +/−10° in 1° steps, that is the angle at which the mutually welded pipes are chamfered at the respective end faces.

Each point of the weld seam can thereby be scanned by the soundwaves emitted by the two groups of elements and can thus be impacted from at least two different angles. The division of the elements of a phased array sensor into a plurality of groups has the result that a plurality of sound entry points can be utilized without axially displacing the test probe in so doing, whereby the region of interest of the weld seam to be tested is impacted a plurality of times starting from different positions and at different angles of the sound beam and the superposition at the irradiated weld seam can thus be increased, which results in an improvement of the test accuracy.

It can be advantageous in some applications to work additionally with two test probes for the emission and detection of sound wavers in the TOFD mode (time of flight diffraction). Diffraction signals of discontinuities can thereby be detected in the pipe material or in a weld seam. The test bodies can be the same as can be used in a phased array arrangement. They can then additionally also be operated in the TOFD mode.

On the carrying out of the method for testing and also on the adjustment using an adjustment body, a check of the coupling of the soundwaves into the pipe to be tested or into the adjustment body should be carried out. An additional group of elements of a phased array sensor can be used for the coupling control. All the elements of a test probe can be used, for example, and soundwaves can be emitted by them perpendicular to the surface of the pipe or of the adjustment body. For the recognition of a defective coupling, a rear wall measured signal (soundwaves reflected from an oppositely disposed wall of the pipe) can be selected which can be easily differentiated from other measured signals. This measured signal can be set at 80% of the screen height and a registration threshold of 40% of the screen height can be set. As soon as the measured signal drops below this threshold value, this is registered and evaluated as an insufficient coupling for the soundwaves used. In the latter case, a check of the coupling medium used or of its supply is required. A coupling medium should be used both in the test and in the adjustment.

The adjustment of the measurement sensitivity can be carried out after a standard adjustment of the sound speed and the distance. In this respect, a depth compensation curve can be prepared, for example, at the respective adjustment body for each group and for each angle. The bases of the blind bores can be bombarded by sound after one another at each angle of the sound beam which is emitted by the elements of a test probe. The bases of the blind bores can in this respect be recorded with different sound paths, that is, for example, after a reflection of the sound beam at a pipe wall and also after 2 reflections of the sound beam at a pipe wall. As a rule, the total sound path range for the test at thin-walled pipes having the named small nominal wall thickness can be covered with three blind hole bores. The differently long paths which sound waves cover within the pipe to be tested, starting from the entry into the pipe material up to the exiting and the incidence on elements of a test probe, up to their detection and the different damping of the measured signals caused thereby can be compensated by means of a depth compensation curve in that measured signal values of soundwaves which have covered a larger path and were therefore damped more are correspondingly amplified or a corresponding measured value increase is carried out.

A recognized defect at a weld seam can always be indicated at the same measured signal level by the depth compensation curve thus determined independently of its depth position and of the angle impacting it. In this process, a depth compensation curve can be stored for each angle of the sector sweep and can be taken into account in a real test. An echo height evaluation and thus a repeatable and reproducible evaluation of faults or defects at a weld seam can thereby be achieved.

An optimum defect localization can be achieved with weld seams in that the emitted soundwave beam is incident perpendicular to the weld seam flank since typically binding defects can occur just at the weld seam flank. In addition, in this respect, all the positions of the weld seam should be scanned/irradiated at at least four different angles. A sufficient redundancy can thereby be achieved.

If the test system to be used allows from a technical aspect, the weld seam shape and the center line should be set at the device.

For a precise positioning of the test probes with respect to the weld seam, an apparatus/test probe holder can be used which ensures an unchanging spacing of the test probes from the weld seam and also from one another and ensures a uniform coupling and has a path sensor.

On a use of a plurality of test probes in a test probe holder, the control body in accordance with claim 8 can be used for the control of the optimum and uniform setting and coupling of the test probes and of the symmetrical alignment of the test probe system at the weld seam. In this respect, the perpendicular bore of all test probes is irradiated by sound and both the measured signal amplitude and the sound paths (transmit time) have to be of equal magnitudes in tight limits with the symmetrically arranged test probes. This test should be repeated at regular intervals to ensure that the test can be carried out without error over a longer time period.

For the test, the apparatus/test probe holder is fastened at the pipe to be tested such that the weld seam is arranged exactly at the center between the two test probes and the spacing of the test probes from the weld seam center corresponds to a predefined value.

Care must be taken that sufficient coupling medium is present between the surfaces of the tube to be tested facing one another or of the adjustment body and the test head(s). The same coupling medium should naturally be used for the adjustment and for the test to ensure the comparability.

In the test, the apparatus/test probe holder or an individual test probe can be moved by 360° about the pipe to be tested or along the total length of a weld seam. The image prepared by means of the detected measured signals can then be frozen and the coupling of the one or both test heads can be controlled at a prepared C image. If the coupling control indicates a proper coupling over the total scan, the data which A images have to contain at every point of the C image can be stored and evaluated.

An evaluation independent of the sound path lengths is possible with the aid of the depth compensation curves which have been determined with the aid of the blind bores at the respective adjustment body. Alternatively, other tools such as comparison lines or fixed threshold values can also be used for the evaluation. In the comparison line method, a comparison line is taken at a comparison body and an echo height evaluation is carried out. The comparison line is used for evaluating the measured signals. Transverse bores, passage bores, flat-base bores, edges, grooves, rear walls, hemispherical bores, etc. can be used as comparison reflectors.

Fixed threshold values are apertures which are dependent on the sound path region and which are fixed at a defined echo height.

If the sensitivity of the adjustment is not sufficient or is too large for the test, an amplification supplement or deduction of the measured signals can be fixed.

Faults/defects having the same reflection properties in different depth positions can nevertheless be indicated or evaluated the same by the adjustment at an adjustment body specific to a special pipe type. Work can be carried out using a simple aperture or a single threshold as a registration boundary or reliability boundary.

The magnitude of the measured signal amplitudes and the depth position which can be seen from the A images, the depth extension which can be seen from the sector image and an extent in the peripheral direction which can be seen from the C image can be used for evaluating faults/defects.

The evaluation of the indicated measured results can take place within the weld seam geometry. For this purpose, a display of the weld seam geometry in the sector image of the ultrasound measured signal can be used. In addition, a very good adjustment of the positioning of the apparatus/test probe holder to the weld seam center within tight tolerances is advantageous.

Longitudinal faults (elongate faults/defects which lie in the axial direction of the pipe) can be detected particularly easily using the method in accordance with the invention.

The typically used X-ray testing can be completely replaced with the ultrasound test by the invention. An avoidance of unnecessary radiation exposure for humans and for the environment can thereby be achieved. A saving of personnel costs in comparison with X-ray testing can be achieved by the simplification of the test method with a simultaneously adequate detection accuracy and the examination times and disturbance times of plants, e.g. in power plants, can be substantially cut. The test time periods can also be planned better. The technique used is less expensive than with X-ray equipment.

The invention can be used particularly advantageously for the testing of corresponding pipes in power plants, petrochemical plant construction or similar.

The invention will be explained in more detail in the following with reference to examples. Features used and shown in the different examples should be able to be used in combination with one another independently of the respective example.

There are shown:

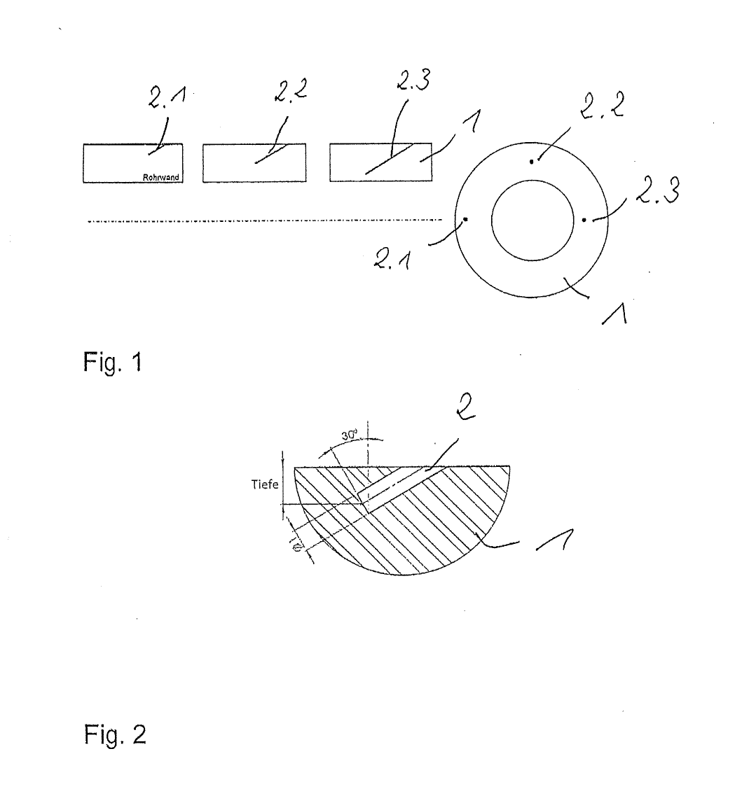

FIG. 1 three schematic sectional representations through an adjustment body each having a blind bore and a side view;

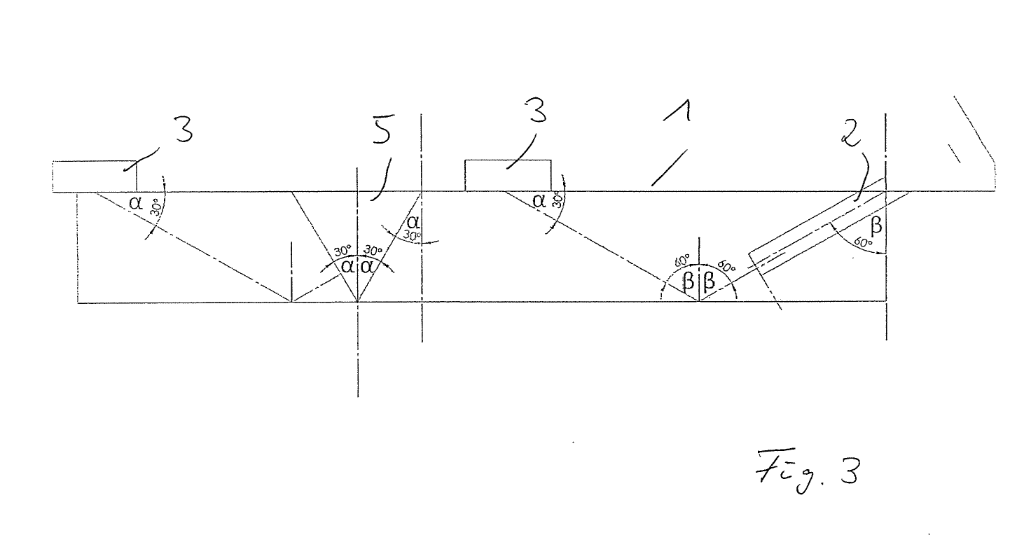

FIG. 2 a detail of a sectional representation of an adjustment body having a flat-base bore;

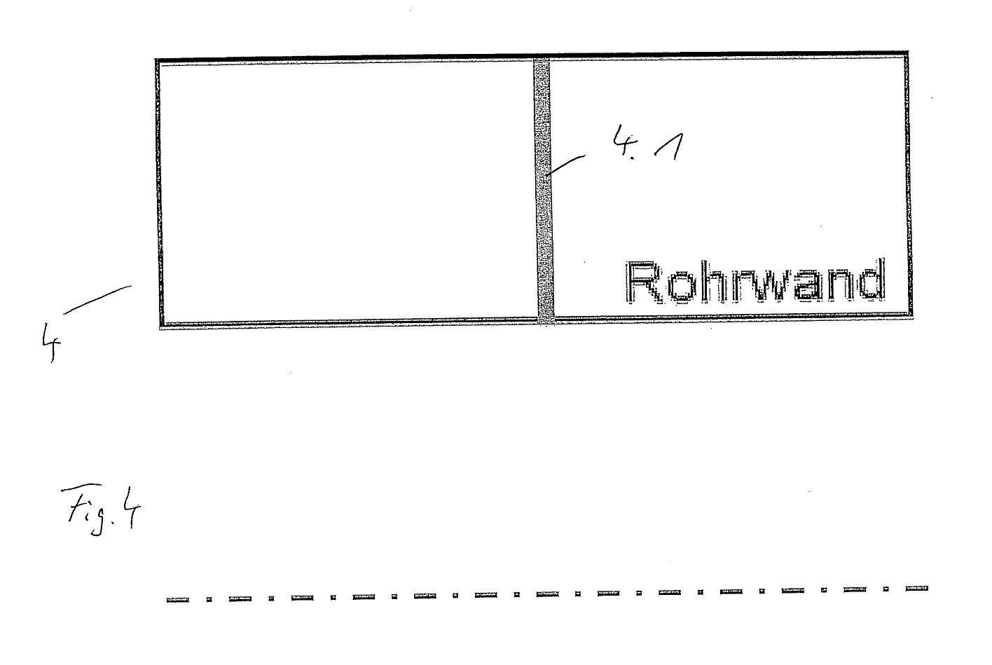

FIG. 3 schematically in a sectional representation, the angle association of test head sound irradiation angle, flank seam preparation weld seam and position of adjustment reflector; and

FIG. 4 an example of a control body with a passage bore.

It can be clearly recognized by the three sectional representations of an adjustment body 1 shown in FIG. 1 that here, for example, three blind bores 2.1, 2.2 and 2.3 are formed in the pipe wall distributed over the periphery of the pipe at a tubular adjustment body 1. The blind bore 2.1 is the shortest in this example and has a length/depth which has ¼ of the nominal wall thickness of a pipe to be tested for which the adjustment body 1 is configured. The blind bore 2.2 has a length/depth which corresponds to ½ of the nominal wall thickness and the blind bore 2.3 has a length/depth which corresponds to % of the nominal wall thickness. The bases of the blind bores are therefore arranged at different spacings from the surface of the adjustment body 1 onto which at least one test probe, not shown, can be set onto the surface at the openings of the blind bores 2.1, 2.2 and 2.3.

The adjustment body 1 is manufactured from the same material as a pipe to be tested. It also has the same wall thickness and the same outer diameter as this pipe to be tested.

It can be recognized by the detail shown in FIG. 2 how a blind bore 2 is formed as a flat-base bore in the material of an adjustment body 1 inclined at an angle of 60° to the surface. The central longitudinal axis of the blind bore 2 is drawn as a chain-dotted line. Accordingly, in FIG. 2, the base of the blind bore 2 is inclined at an angle of 30° with respect to the surface of the adjustment body 1. This angle corresponds to the angle at which the surfaces of the pipes which are welded to one another have been chamfered in the weld seam preparation.

In the adjustment, the soundwaves are used which are reflected back from the base of the blind bore 2.

To test round seams at pipes having an outer diameter of 31.8 mm and a wall thickness of 4.0 mm and the material X, an adjustment body 1 of the same material and of the same dimensions (outer diameter and wall thickness) is required. The control body 4 should also have these properties. Under the assumption that the weld seam flanks were prepared before the welding of the pipe ends which are welded to one another at the angle α=30° (see FIG. 3), blind bores 2.1, 2.2. 2.3 having a flat base should be introduced into the adjustment body 1, the blind bores having been introduced at an angle of β=60° in accordance with FIG. 3. It is recommended here to introduce three bores having the base in three different depths in the pipe wall of the adjustment body 1, e.g. in the depths 1 mm, 2 mm and 3 mm. A diameter of the flat base of 1 mm is recommended. A perpendicular bore 4.1 is introduced at a far remote point from the flat-base bores as a control reflector or in an additional pipe as a control body 4 which as a diameter of 1 mm. In FIG. 3, a weld seam 5 is additionally shown which is not formed at the adjustment body 1, but rather at the pipe to be tested. In this respect, the parts/surfaces to be welded to one another in the seam preparation are here formed inclined at an angle α of here

30° with respect to a reference line drawn perpendicular through the wall of the pipe or at an angle β of 60° inclined with respect to the pipe surface.

2 phased array test probes 3 which each have 32 elements are used for the test. They are each divided into 3 groups:
Group 1: Sector sweep between 50° and 70° (in 1° steps) with the elements 1-16
Group 2: Sector sweep between 50° and 70° (in 1° steps) with the elements 17-32
Group 3: Linear 0° with the elements 1-32

The three flat-base bores in the adjustment body 1 are irradiated by sound by hand using these two test probes 3 and the above-named settings, the sensitivity is recorded and thus a depth compensation curve recorded. The test probes 3 are then installed into the test probe holder which is adapted to the outer diameter of 31.8 mm. The spacing between the test probes 3 is set in a defined manner and the control of the test system is carried out at the perpendicular bore of the control body 4. The echo height (amplitude of the measured signal) of the bore 4.1 with the comparable groups of both test probes here has to be of almost the same magnitude, just like the indicated sound path. The test probe holder is then placed around the weld seam to be tested and aligned centrally. The test probes 3 are led with the holder slowly once by 360° about the pipe and a recording of the data is carried out in so doing. If the coupling control (respective group 3 of the test probe) does not continuously deliver any indications, the recording is stored and can be evaluated at any desired time later.

A control body 4 having a bore 4.1 formed perpendicular to the surface is shown in FIG. 4.

1. A system for the nondestructive testing of metal fusion welds at thin-walled pipes having a maximum wall thickness of 6 mm comprising at least one test probe for the emission and detection of soundwaves; and
comprising at least one adjustment body (1) which is formed from a material which is the same or a material having at least approximately the same acoustic properties as the respective pipe to be tested; and
whose outline dimensions and the diameters/thicknesses are at least approximately the same as those of the respective pipe to be tested, wherein
a plurality of blind bores (2.1, 2.2, 2.3) each having different lengths/depths starting from their openings to their bases are formed in the adjustment body (1).

2. A system in accordance with claim 1, characterized in that the blind bores (2.1, 2.2, 2.3) are aligned in the adjustment body (1) such that the central longitudinal axis of the blind bores (2.1, 2.2, 2.3) is aligned at an angle α with respect to the surface of the adjustment body (1) from which soundwaves are coupled into the adjustment body (1) and soundwaves are coupled into the adjustment body (1) at the same angle α.

3. A system in accordance with claim 1 or claim 2, characterized in that blind bores (2.1, 2.2, 2.3) are formed as a flat-base bore or as a blind bore having a hemispherical base.

4. A system in accordance with one of the preceding claims, characterized in that blind bores (2.1, 2.2, 2.3) having a depth of ¼, ½ and ¾ of the nominal wall thickness of the respective thin-walled pipe to be tested are formed in the adjustment body (1).

5. A system in accordance with one of the preceding claims, characterized in that the at least one test probe (3) is a phased array sensor whose elements emitting and detecting soundwaves can be operated in a plurality of groups and the individual groups are in this respect operated individually independently of one another.

6. A system in accordance with one of the preceding claims, characterized in that a test probe (3) is configured such that emitted soundwaves can be coupled, starting from a plurality of positions, into the material of the respective thin-walled pipe and of the adjustment body (1) and are incident at different angles onto bases of blind bores (2.1, 2.2, 2.3) of an adjustment body (1) and onto a weld seam of the respective thin-walled pipe.

7. A system in accordance with one of the preceding claims, characterized in that two test probes (3) are held fixed in a common test probe holder at a respective constant spacing from one another and at the respective same spacing from the center axis of the weld seam to be tested; or in that at least two test probes (3) are held fixed in a common test probe holder at a respective constant spacing from one another, but on the same side of the weld seam to be tested.

8. A system in accordance with one of the preceding claims, characterized in that a control body (4) is formed in which a passage bore (4.1) is formed perpendicular to a surface from which soundwaves are coupled in and the control body (3) is formed from a material which is the same material or is a material having at least approximately the same acoustic properties as the respective thin-walled pipe to be tested; or
in that a passage bore formed perpendicular to the surface of the adjustment body (1) is additionally formed in the adjustment body (1).

9. A method for the nondestructive testing of metal fusion welds at thin-walled pipes having a maximum wall thickness of 6 mm using a system in accordance with one of the preceding claims, wherein a test of a pipe and an adjustment using at least one test probe (3) are carried out, wherein
soundwaves are coupled in by the test probe (3) at a plurality of positions and at different angles from the surface of the respective pipe to be tested and from the surface of the adjustment body (1) and in this respect are directed onto the weld seam of the pipe and are directed onto bases of blind bores (2.1, 2.2, 2.3) in the adjustment; and
the sound waves reflected back are detected by this or another test probe (4) and a comparison is carried out using the detected measured signal amplitude(s) for an exceeding or falling below of a predefinable threshold value for recognizing a fault/defect.

10. A method in accordance with claim 9, characterized in that depth compensation curves are determined by means of the known configuration and position of the bases of the blind bores (2.1, 2.2, 2.3), with which depth compensation curves a compensation of the damping is achieved with differently long paths which soundwaves cover in the material of the thin-walled pipe, by an amplification of measured signals which were detected using soundwaves which had to cover a longer path than other soundwaves which were reflected in the interior and which had in particular been coupled in close to the surface.

11. A method in accordance with claim 9 or claim 10, characterized in that elements of a phased array sensor emitting and detecting soundwaves are combined into at least two groups.

12. A method in accordance with one of the claims 9 to 11, characterized in that, on the adjustment, soundwaves are directed to the surface of the bases of blind bores (2.1, 2.2, 2.3) and soundwaves reflected from there are detected.
